(19) United States
(12) Patent Application Publication
(10) Pub. No.: US 2010/0205228 A1
(43) Pub. Date: Aug. 12, 2010

(54) SYSTEM AND METHOD FOR CREATING USER CUSTOMIZED INSTRUCTIONAL MEDIA

(75) Inventor: Kenneth Duan Reese, Kirkwood, MO (US)

Correspondence Address: HARNESS, DICKEY, & PIERCE, P.L.C, 7700 Bonhomme, Suite 400, ST. LOUIS, MO, 63105, US

(73) Assignee: Ramp Operating Company, L.P., Kirkwood, MO (US)

(21) Appl. No.: 12/367,220

(22) Filed: Feb. 6, 2009

(51) Int. Cl. G06F 17/30

(52) U.S. Cl. 707/805; 707/E17.01

(57) ABSTRACT

A method of providing a user customized instructional media file from a database containing a plurality of instructional media files is disclosed. The method includes identifying a plurality of the instructional media files based at least in part on a plurality of parameters selected by the user and stitching the identified plurality instructional media files into a compiled instructional media file. The method further includes making available for delivery the compiled instructional media file to the user. Additional methods and systems for performing the methods are also disclosed.

### FIELD

The present disclosure relates to creating user customized instructional media.

### BACKGROUND

This section provides background information related to the present disclosure which is not necessarily prior art.

When a person desires to learn a new skill or how to perform a certain task, there are many options available. The person may read a book, take a class on the subject or hire someone to provide instruction, guidance and encouragement. Prepared instructional audio and video tapes, DVDs and electronic files are also available for these purposes.

### SUMMARY

This section provides a general summary of the disclosure, and is not a comprehensive disclosure of its full scope or all of its features.

According to one aspect of the present disclosure a method of providing a user customized instructional media file from a database containing a plurality of instructional media files is disclosed. The method includes identifying a plurality of the instructional media files based at least in part on a plurality of parameters selected by the user and stitching the identified plurality instructional media files into a compiled instructional media file. The method further includes making available for delivery the compiled instructional media file to the user.

According to another aspect of the present disclosure, a method of providing remote customized instruction to a user over a network is disclosed. The method includes receiving a plurality of parameters from the user and selecting based at least in part on the parameters at least two instructional media files from a plurality of instructional media files stored in a database. The method also includes retrieving the selected instructional media files from the database and stitching the retrieved instructional media files into a compiled instructional media file. Further, the method includes delivering the compiled instructional media file to the user.

According to yet another aspect of the present disclosure, a computer system for providing customized instruction to a remote user via a network is disclosed. The system includes a database server for storing a plurality of instructional media files, an application server for creating compiled instructional media files from the plurality of instructional media files and a network server for sending data to and receiving data from a user via the network, the network server providing said received data to the application server.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a method of providing a user customized instructional media file according to the present disclosure.

FIG. 2 is a system for providing a user customized instructional media file.

FIG. 3 is a diagram of an example series of pages for a system for providing a user customized exercise video.

FIG. 4 is an example representation of a video building page of the system in FIG. 3.

FIG. 5 is an example representation of a video building page after the user has selected a category from the page in FIG. 4.

FIG. 6 is an example representation of a video building page after the user has selected various subcategories from the page in FIG. 5.

FIG. 7 is an example representation of a video building page for ordering video segments after the user has selected from the page in FIG. 6.

FIG. 8 is an example home page of the system in FIG. 3.

FIG. 9 is an example trainer selection page of the system in FIG. 3.

FIG. 10 is an example of an additional trainer information page of the system in FIG. 3.

FIG. 11 is an example workout library page of the system in FIG. 3.

FIG. 12 is an example workout creation page of the system in FIG. 3.

FIG. 13 is an example user video page of the system in FIG. 3.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

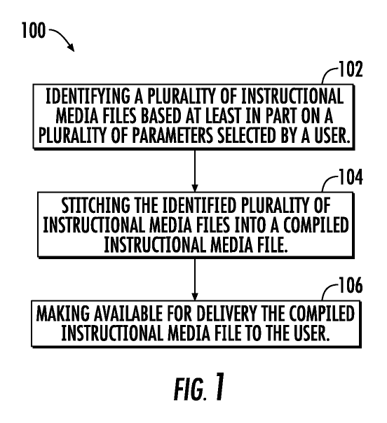

According to one aspect of the present disclosure illustrated in FIG. 1, and as noted above, a method, generally indicated by reference numeral 100, of creating a user customized instructional media file from a plurality of instructional media files includes at 102 identifying a plurality of the instructional media files based at least in part on a plurality of parameters selected by the user. The method also includes, at 104, stitching the identified plurality of instructional media files into a compiled instructional media file and, at 106, making available for delivery the compiled instructional media file to the user.

The instructional media files may be prerecorded instructional media files stored in a digital format. The instructional media files may be audio, video, text, or any combination of audio, video and text. The instructional media files can be stored in any suitable digital format, including AVI, WMV, MP4, DIVX, FLV, etc. for video files, MP3, WMA, etc. for audio files, and TXT, DOC, etc. for text files. After the instructional media files have been created, i.e. taped, filmed, recorded, typed, etc., they are converted to an appropriate file format and stored. Alternatively, or additionally, the instructional media files may not be prerecorded and, for example, may be a live broadcast.

Media characteristics of the instructional media files may be stored in a database. The media characteristics typically include information about characteristics, including the location of the file, indexed to the associated instructional media file. The instructional media files can be characterized according to various defining parameters. For example, the file format, the time length of the file, the general subject of instruction, the specific subject of the instruction, any required items/equipment/parts/ingredients, the required skill level of the viewer, the intensity of the contents of the file, the performers/authors of the instruction, any use restrictions, function of the media file, use of the file, etc., may be used as defining parameters (also sometimes referred to as media characteristics) for the instructional media files.

A user who desires a compiled instructional media file comprising one or more of the instructional media files provides, through a computer program, website, kiosk, etc., a plurality of parameters for the compiled instructional media file. The plurality of parameters can include, for example, universal parameters and/or temporary parameters. Universal parameters may be created by creating a user profile. The user profile typically includes certain universal parameters that are applied to each compiled instructional media file created by the user. These universal parameters for the compiled instructional media files set by the user profile can include, for example, the desired file format, the desired length of time, specific relevant equipment available to the user, etc. Thus, anytime the user desires a new compiled instructional media file, the universal parameters can be applied as default parameters without the user needing to resupply the parameters. The temporary parameters will typically change each time the user creates a new compiled instructional media file. These temporary parameters can include, for example, the general type of instruction desired, the specific instruction (e.g., subcategories) desired, an order of instruction (where applicable), the instructor desired, etc. Other universal and/or temporary parameters may apply depending on the type of instruction provided by the instructional media files.

After the user parameters, whether temporary, permanent or both, are received, a plurality of the instructional media files may be identified based, at least in part, on the parameters by a computer using appropriate software. The database is searched for indexed instructional media files which meet the criteria established by the parameters. In some instances the search may find only one or no instructional media files that meet the parameters. In such cases the user may be informed that no files meet the parameters, may be provided with possible alternatives that do not meet the parameter, may be provided with the instructional media files which meet some of the parameters, may be prompted to try another set of parameters, etc.

In some embodiments, the user may select the order of the instructional media files in the compiled instructional media file after the instructional media files are identified and presented to the user. If such an option is available, the user is shown a list of the identified instructional media files. The user then selects the order of presentation of the instructional files in the compiled instructional media file by, for example, dragging the files into order, numbering the files, etc. In other embodiments, the ordering of the instructional media files in the compiled instructional media file is performed automatically without user action.

The identified instructional media files are then stitched, combined, joined, etc. into a compiled instructional media file. The compiled instructional media file may be a single file including all of the identified and ordered instructional media files. The stitching is typically performed by software. Software capable of such stitching includes, for example, Microsoft's .NET platform of tools. The stitching is generally performed by reading the identified instructional media files, stripping, removing, deleting, etc. file headers and/or footers, as applicable, and writing the instruction media file to a separate compiled instructional media file. Alternatively, identified instructional media files may be read in sequence and re-encoded into a single formatted media file. Such a single formatted media file may be the same format or a different format from the identified instructional media files. However, other ways may also be employed to stitch the instructional media files into a compiled instructional media file.

Additional media files may also be included in the compiled instructional media file. For example, all compiled instructional media files may include, for example, an advertisement, a warning, a disclaimer, or an introduction. Additionally, each instructional media file may include additional media files, such as an introduction, basic instruction, etc. These additional media files are not necessarily, but may be, selected or included according to the user selected parameters. For example, a user may not be able to make any selections, including parameter selections, which will prevent inclusion of a warning or disclaimer in the compiled instructional media file, but may be able to set the user's parameters to prevent inclusion of introductory or basic instruction media files. In some embodiments the user may prevent inclusion of advertisements in the compiled instructional media file by payment of a fee.

After the desired instructional media file is compiled, it is made available for delivery to the user. The compiled instructional media file may be available for delivery via any suitable means including, for example, downloading (automatically, by web browser link, etc.), file transfer protocol (FTP), sent via email as an attachment, burned to a CD or DVD, stored in a flash memory drive, etc. The user can thus acquire the compiled instructional media file and view/listen to the compiled instructional media file at the user's convenience on a computer, cell phone, MP3 player, television, etc. The compiled instructional video may also be stored on a flash memory drive, CD, DVD, or other media by a provider of goods and services according to the methods disclosed herein and physically mailed to the user via postal mail or made available for pickup by the user.

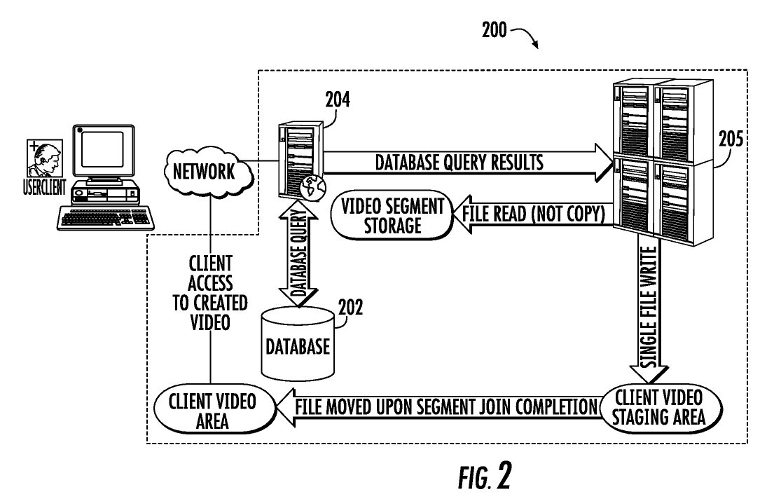

An example system 200 for performing this method is illustrated in FIG. 2. The system includes a database server 202 for storing the plurality of instructional media files. The system also includes a network server 204 for interfacing with a user over a computer network (e.g. the Internet). An application server 206 includes software or other suitable instructions for joining the instructional media files into the compiled instructional media file.

The system 200 is typically accessed by a user remotely, i.e. via a network. The network may be a local area network (LAN), a wide area network (WAN), the Internet (including the World Wide Web), or any other suitable computer or media network. A graphical user interface (GUI) is provided to permit the user to interface with the system 200. The GUI can be a stand-alone, i.e. software based GUI (installed on a user's computer or a computer useable by the user), or may be viewed via a web browser. A browser based GUI allows the user to access the system 200 via a we browser without needing to download other specific software (except, of course, a browser and any plug-ins necessary to view the browser based GUI). The GUI may include Hyper Text Markup Language (HTML), Java, or other suitable computer languages.

The method and system described above can be used for instruction in any subject. Some example instructional subjects include exercise, dieting, cooking, auto repair and knot-tying. The system and method discussed above will be further elucidated below using some example instructional subjects.

Many people exercise, or desire to exercise, with a personal trainer. A personal trainer typically instructs a person how to properly use exercise equipment, how to properly perform specific exercises and provides suggested exercises or groups of exercises to help meet the person's goals. Personal trainers also provide encouragement and motivation to the person while exercising. The method discussed above allows a user to remotely create customized compiled instructional media files for exercise with a video, audio or text based personal trainer at the user's convenience. Although the compiled instructional media file may be audio, video, text, or some combination thereof, the following example will be discussed with reference to video files.

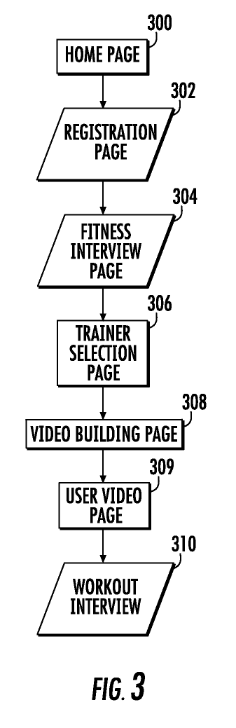

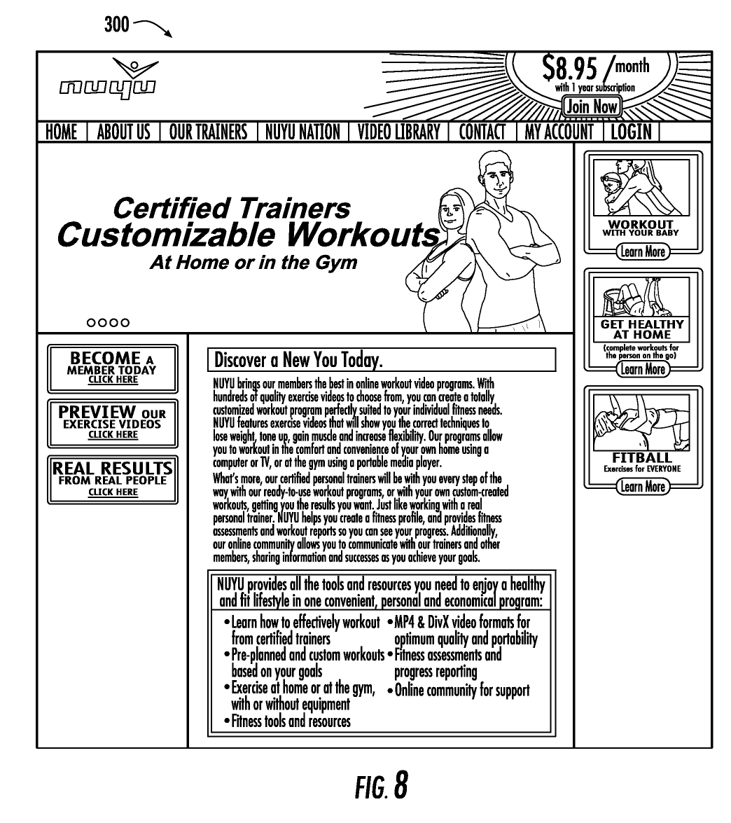

When a user directs a browser to a network address of a system for performing the method herein, the user first encounters a home page 300, as shown in FIG. 3. An example home page 300 is illustrated in FIG. 8. The various pages described herein may each be a single page or several separate pages, but will be referred to herein in the singular. The home page will typically include information about the method and the instructions available. The home page may also include pricing information. Users who have already registered (when applicable) may login from the home page and proceed to the video building page discussed below. If an unregistered user desires to use the services, the user proceeds to the registration page 302. On the registration page, the user is asked to provide registration information. Such information typically includes the user's name, address and payment information. The user may also be able to select different levels of service, such as unlimited, one time use, a certain number of customized videos per month, etc.

After completing the registration, the user proceeds to the fitness interview page 304. The user completes the fitness interview page 304 by providing answers to various fitness questions. Such questions may include the user's age, gender, general fitness level, skill level, activity level, body measurements, profession, goals, type of trainer preferred, daily caloric intake, injuries or ailments, whether the user smokes, whether the user is pregnant (if female), equipment available to the user, etc. On the fitness interview page or on a separate profile page, the user may enter additional default parameters as discussed above. The results of the user's fitness interview and/or the profile selections are stored as a user profile and used as parameters for the creation of compiled instructional media files.

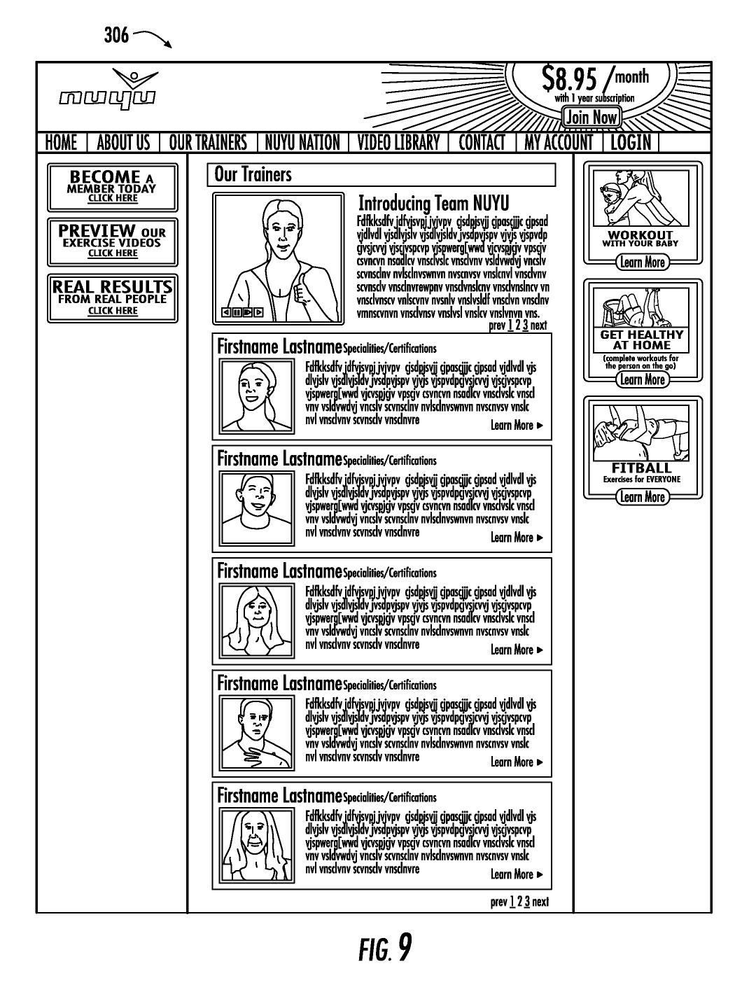

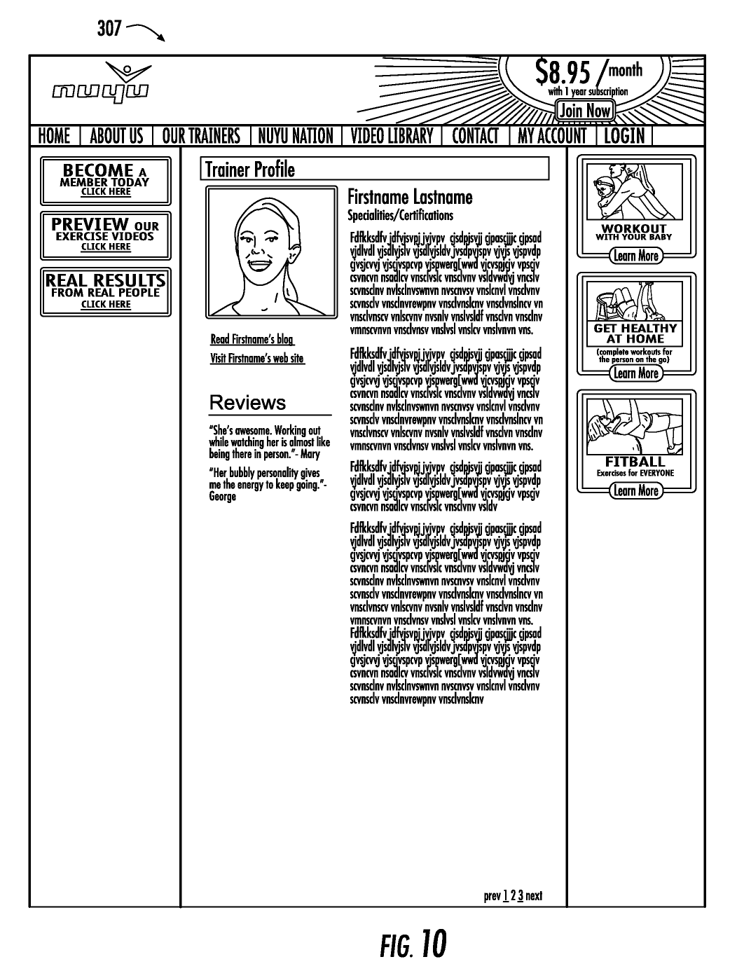

When the user is ready to build an exercise video, the user navigates to the trainer selection page 306. One example trainer selection page 306 is illustrated in FIG. 9. On this page, the user is shown information about available personal trainers. This page may include photographs and video of each of the available trainers, summary biographical information, links to the trainers' personal websites, links to the trainers' blogs, etc. If so desired, the user may view additional information about a trainer on a trainer detail page 307 as illustrated in FIG. 10. The trainer detail page 307 may include photographs and video of each of the available trainers, biographical information, links to the trainers' personal websites, links to the trainers' blogs, etc. and the user may view preview videos of the various trainers' instructional video files from the trainer detail page 307. The trainers are actual personal trainers and the biographical information is information about the actual personal trainers appearing in the video segments. To continue building the user's custom compiled instructional video file, the user selects one of the trainers. Alternatively, or additionally, the user may select a default trainer as a user parameter for all compiled instructional video files to be created by the user, or may select from videos without regard to trainer (i.e., the user may select videos from more than one trainer for inclusion in a compiled instructional video file).

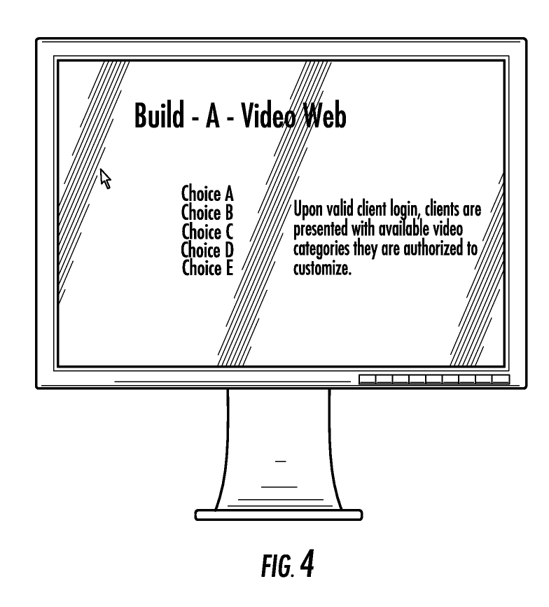

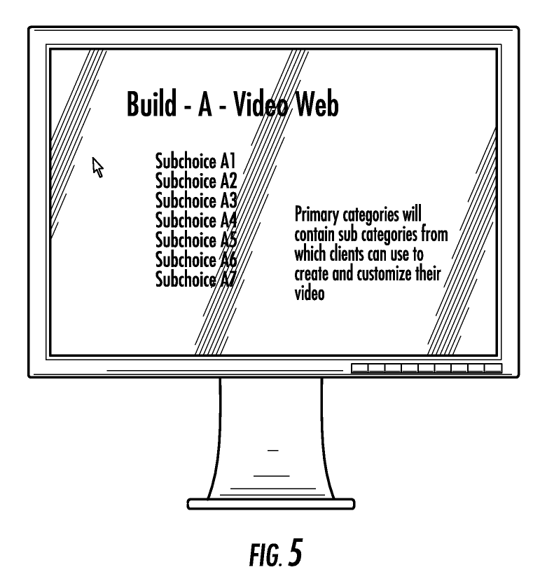

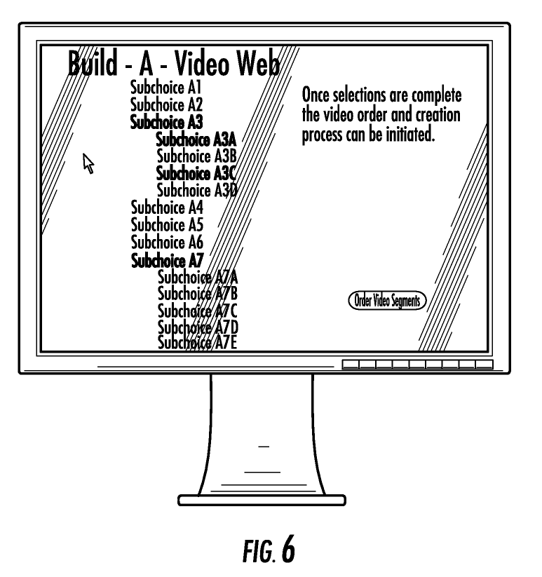

After the trainer is selected, when applicable, the user is directed to the video building page 308. On this page the user begins by selecting a desired length of time for the desired instructional video file. As seen in FIG. 4, the user is presented with available general categories of instruction, such as cardiovascular exercise, weight training, etc. The selection of the general category brings up available subcategories, as seen in FIG. 5. For example, if the user selected weight training, the available subcategories can include upper body, lower body, total body, core strength, etc. When the user selects the subcategory, additional nested sub-subcategories may be available (as seen in FIG. 6). This allows the user to specify not only upper body strength training, but specifically arms, legs, chest or back, for example. In some instances, the user may be presented with additional choices after selecting a specific body part. Thus, if desired, the user may drill down to the level of selecting the specific exercises desired. If the user continues to select more and more specificity, the user may arrive at a point where the user is presented with the specific instructional video segments from which the user may select. Additionally, or alternatively, the user may also perform a search for video segments using a search tool.

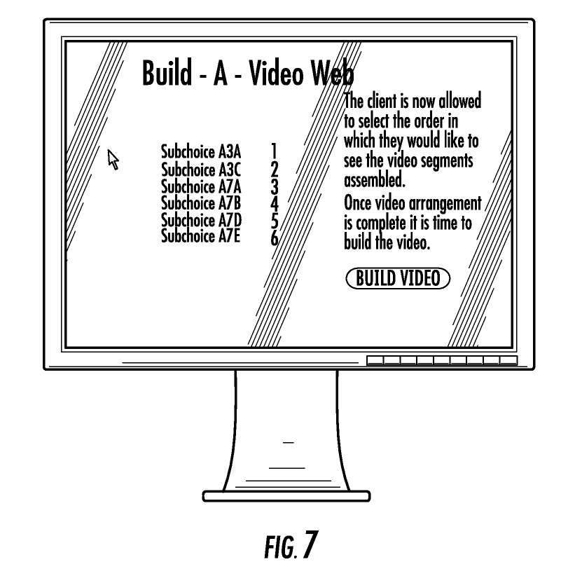

The user may stop at a more general level, such as strength training-upper body-arms, and allow the system to select the specific instructional videos segments based on the user's parameters in the manner discussed above. When the user finishes the selection process, the system searches the database to determine, based at least in part on the user parameters, the matching instructional video segments. These segments, as shown in FIG. 7, are presented to the user for ordering, if desired. Alternatively or additionally, the system can itself order the segments. The user may also select a name for the compiled instructional video file or allow the system to generate a name. Typically, an auto-generated name will be the user's login name combined with the date and time of creation.

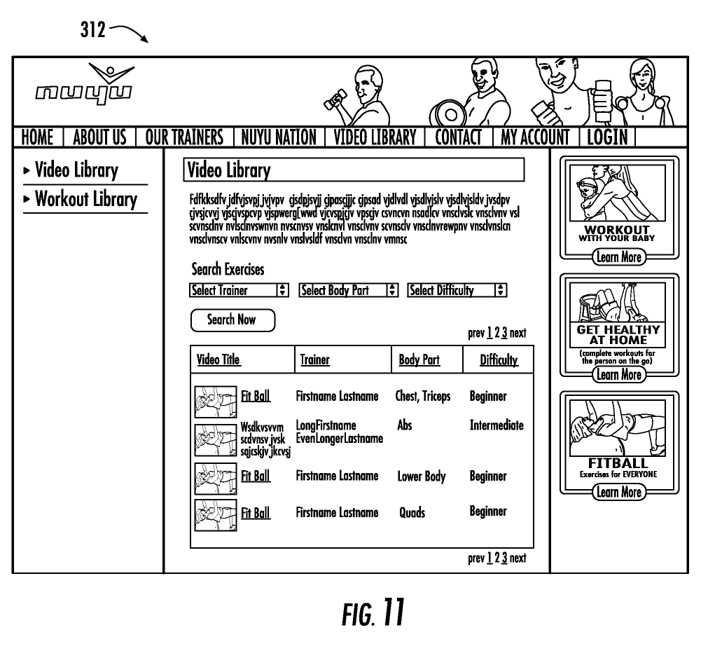

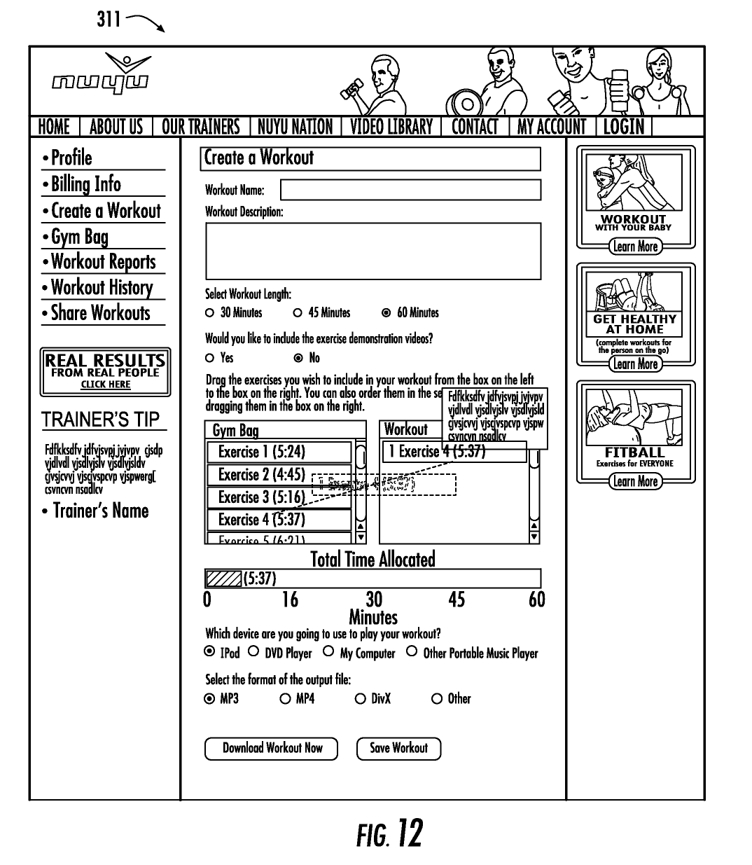

One multi-page example of the video building page 308 is illustrated in FIGS. 11 and 12. FIG. 11 illustrates a workout library page 312. On the workout library page, a user can search available videos by various categories. For example, the user may search by trainer, body part, difficulty level, or some combination thereof. Videos matching the user's search criteria are displayed. The user may select a video to view additional information about the video and/or add the video to a gym bag (i.e. a wish list, shopping cart, etc.). After the user has selected the desired instructional video segments, the user navigates to workout creation page 311, illustrated in FIG. 12. On this page, the user can name and describe the workout to be created. The user may also select the desired length of the compiled instructional video, a device with which the video will be used (e.g., a portable media player, a computer, media server, etc.) and the desired format of the compiled instructional video. As can be seen, the video segments that were added to the user's gym bag are shown on the workout creation page 311. The user can select which video segments to include and the order in which to include them. After the user has completed all required fields of the workout creation page 311, the user may request the compiled instructional video file be created by clicking on a create video button, link, image, etc.

When the user requests creation of the compiled instructional video file, a map file is created by the system and saved. Alternatively, the map file may be created after, or concurrently with, the compiled instructional video file. The map file contains the necessary information to create, or recreate at another time, the compiled instructional video file. For example, the map file includes identification of the selected segments and the order in which the segments are to be placed.

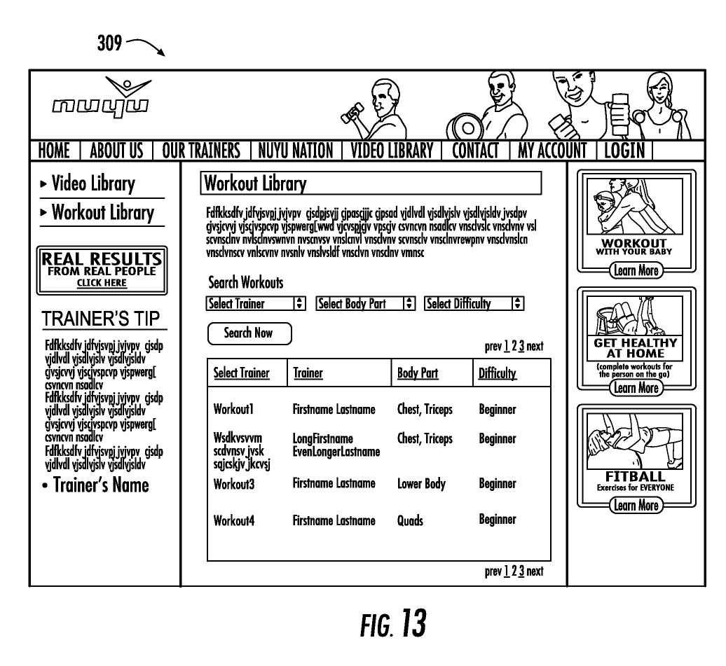

The system then combines the selected video segments into the compiled instructional video file in a staging area. In some embodiments, this is done programmatically using Windows API functions compiled in avifil32.dll and msvfw32.dll files. The system then temporarily stores the compiled instructional video file. A link to the stored file is inserted into a user video page 309 accessible by the user. One example user video page 309 is illustrated in FIG. 13. The user may then download the compiled instructional video file to his computer, flash drive, media player, etc. and view the compiled instructional video file. Alternatively, the compiled instructional video may be delivered to the user via other methods. For example, the compiled instructional video may be sent to the user by email, or stored on a USB drive, CD, DVD, or other media and physically mailed to the used via postal mail, etc.

Some time after the compiled instructional video file is created, such as 24 hours, the compiled instructional video file is deleted from the system. The map file, however, is retained. Thus, if a user selects to download a compiled instructional video file that has already been deleted, the system automatically restitches the compiled instructional video file according to the instructions in the map file and makes the compiled instructional video file again available to the user.

The instructional media files, or video segments, can be stored in the database in all of the available file formats. For example, the video segments may be available in formats such as DIVX, WMV, MP4, FLV, etc. Each video segment may be separately stored in each of the available formats (e.g., one copy of each video segment stored in each of DIVX, WMV, MP4, FLV, etc.). The compiled instructional video file is stitched together using the video segments in the format that the user has selected for the compiled instructional video file. Alternatively, or additionally, each video segment may be stored and stitched in a single format and the compiled instructional video file may then be converted to a user desired format (if different from the format in which the video is stored).

The video segments can vary in length and content. The length of the individual segments can be anywhere from one minute to two hours. The length of time depends on the content which is presented in the specific segment. For example, the video segments may include the selected trainer explaining the exercise to be performed and, if applicable, explaining how to use equipment needed for a specific exercise. The personal trainer may also demonstrate the exercises and instruct the user how many repetitions to perform and when to begin. The video segments may also include video of the trainer performing the exercises when the user is to perform them and/or video of another person (or group of people) performing the exercises while the trainer provides instruction, advice and/or encouragement. For example, in a video segment for sit-ups, the trainer may instruct the user to perform 20 sit-ups. The trainer may then be shown performing the 20 sit-ups and counting them for the user to perform along with the trainer or a group of people (or a single person not the trainer) may perform the 20 sit-ups while the trainer counts them out. The trainer may also give audio encouragement in a manner similar to working with a live trainer. Thus, the trainer may be heard on the video to tell the user “good job”, “only 2 more reps left”, “you can do it”, etc. The initial trainer demonstration of the exercises may be omitted according to the user's preferences or temporary selection. Thus, if a user has previously viewed a video segment on, for example, sit-ups and the user desires to include the same video segment in a new compiled instructional video, but no longer needs to be instructed on how to perform a sit-up, the user may select to not include the demonstration portion of the video segment in the new compiled instructional video. Hence, when the new compiled instructional video file is created as described above, the demonstration portion is not included.

After the user has finished exercising with the compiled instructional video file, the user can complete a workout interview. On the workout interview page 310, the user is presented with questions about the workout. The workout interview questions are based on the specific exercises that were to be performed according to the compiled instructional video file. Questions may include number of repetitions performed, amount of weight/resistance utilized, intensity rating (e.g, as perceived by the user, measured by a monitoring device, etc.), number of sets completed, extra repetitions performed, etc. This post-training question and answer session is used to further personalize the experience, more closely replicate working with a live personal trainer, track the user's progress over time, etc.

In another embodiment, the desired instructional video may relate to cooking. In such an embodiment, the user completes a cooking skills interview instead of a fitness interview. The user rates, for example, his cooking skill level, available equipment, specific food preferences, allergies, etc. The user then selects from a group of cooking instructors or cooking styles (e.g., Italian, Chinese, American, French, Fusion, Creole, etc.) instead of personal trainers. The instruction categories and subcategories may then be selected. The categories, for example, may be breakfasts, lunches, dinners, snacks, desserts, etc. Alternatively, the user may select a cooking style for the category. Either way, the subcategories are then logical subcategories of the selected category. In the same manner as discussed above, the user can select down to a very specific instruction (for example spaghetti marinara, garlic bread and a salad) or a broader request (for example Quick Italian dinner). The system then stitches together instructional video segments into a compiled instructional video file and makes the compiled file available to the user.

The methods of the present disclosure may be applied to almost any subject matter. For example, the instruction may be in subjects such as auto repair, martial arts, knot tying, home repair, computer repair, computer use, etc.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method of creating a user customized instructional media file from a database containing a plurality of instructional media files, the method comprising:
identifying a plurality of the instructional media files based at least in part on a plurality of parameters selected by the user;
stitching the identified plurality of instructional media files into a compiled instructional media file; and
making available for delivery the compiled instructional media file to the user.

2. The method of claim 1 wherein the plurality of parameters include at least one media file parameter.

3. The method of claim 2 wherein the at least one media file parameter includes a length of time.

4. The method of claim 2 wherein the at least one media file parameter includes a format for the compiled instructional media file.

5. The method of claim 1 wherein the plurality of parameters include at least one instructional category.

6. The method of claim 1 wherein the plurality of parameters include at least one user preference.

7. The method of claim 6 wherein the user preference includes types of equipment available to user.

8. The method of claim 6 wherein the user preference includes the user's skill level.

9. The method of claim 6 further comprising receiving the user preference from the user.

10. The method of claim 1 wherein the user is at a location physically remote from the database.

11. The method of claim 10 wherein making available for delivery includes making available for delivery to the user via a network.

12. The method of claim 10 further comprising receiving the parameters from the user via a network.

13. The method of claim 1 further comprising creating a map file that identifies the instructional media files and an ordering of the instructional media files.

14. The method of claim 13 further comprising deleting the compiled instructional media file a period of time after making it available for delivery to the user.

15. The method of claim 1 wherein the instructional media files are instructional video files.

16. The method of claim 1 wherein the instructional media files are instructional audio files.

17. The method of claim 1 wherein the instructional media files are instructional text files.

18. The method of claim 1 wherein the instructional media files include personal training media files.

19. A computer system having software for performing the method of claim 1.

20. A computer readable medium containing instructions for performing the method of claim 1.

21. A computer readable medium containing the compiled instructional media file produced by the method of claim 1.

22. The method of claim 1 wherein identifying a plurality of the instructional media files includes identifying at least one instructional media file selected by the user.

23. A method of providing remote customized instruction to a user over a network, the method comprising:
receiving a plurality of parameters from the user;
selecting based at least in part on the parameters at least two instructional media files from a plurality of instructional media files stored in a database;
retrieving the selected instructional media files from the database;
stitching the retrieved instructional media files into a compiled instructional media file; and
delivering the compiled instructional media file to the user.

24. The method of claim 23 further comprising receiving a plurality of user preferences from the user.

25. The method of claim 24 wherein selecting includes selecting based at least in part on the user preferences.

26. A computer system having software for performing the method of claim 23.

27. A computer system for providing customized instruction to a remote user via a network, the system comprising:
a database server for storing a plurality of instructional media files;
an application server for creating compiled instructional media files from the plurality of instructional media files; and
a network server for sending data to and receiving data from a user via the network, the network server providing said received data to the application server.

28. The system of claim 27 wherein the network server is a web server.

29. The system of claim 27 wherein the system includes a graphical user interface (GUI) for displaying data to the user.

30. The system of claim 29 wherein the GUI is configured to permit the user to provide data and transmit such data to the network server.

31. The system of claim 27 wherein the application server includes instructions for reading at least two of the instructional media files from the database server based at least in part on data received from the user via the network.

32. The system of claim 31 wherein the application server further includes instructions for stitching the at least two instructional media files into a compiled instructional media file.

33. The system of claim 32 wherein the compiled instructional media file is a single media file.
